(19) United States
(12) Patent Application Publication
(10) Pub. No.: US 2017/0131787 A1
(43) Pub. Date: May 11, 2017

(54) METHOD FOR INPUTTING AT LEAST ONE ALPHANUMERIC CHARACTER BY USING A USER INTERFACE OF AN ELECTRONIC DEVICE

(71) Applicant: Orange, Paris (FR)

(72) Inventors: Richard Guignon, Amanlis (FR); Nathalie Gaucher, Paris (FR); Cedric Bertolus, Montrouge (FR)

(21) Appl. No.: 15/322,342

(22) PCT Filed: Jun. 11, 2015
(86) PCT No.: PCT/FR2015/051541

§ 371 Date: Dec. 27, 2016

(30) Foreign Application Priority Data
Jun. 27, 2014 (FR) 1456094

(51) Int. Cl. G06F 3/023; G06F 3/0488; G06F 3/0485

(52) U.S. Cl. CPC G06F 3/0236; G06F 3/0485; G06F 3/0488

(57) ABSTRACT

A method for inputting at least one alphanumeric character by a user interface of an electronic device. The user interface has a display screen with a first display area for displaying at least one entered alphanumeric character, and a second display area for displaying an alphanumeric character that is being entered. The electronic device also has a command input element for inputting a scrolling control for scrolling alphanumeric characters displayed in the second display area. The method includes: detecting a scrolling command input by the command element triggering a scrolling of alphanumeric characters applied to a character in the second display area, displaying a current character in the second display area following the scrolling, detecting an event of entering the current alphanumeric character, displaying, following the detection of the event, the current character in the first display area, and deleting the current character from the second display area.

### CROSS-REFERENCE TO RELATED APPLICATIONS

This Application is a Section 371 National Stage Application of International Application No. PCT/FR2015/051541, filed Jun. 11, 2015, the content of which is incorporated herein by reference in its entirety, and published as WO 2015/197936 on Dec. 30, 2015, not in English.

### FIELD OF THE DISCLOSURE

The invention belongs to the field of user interfaces and, more particularly, relates to a method for inputting at least one alphanumeric character on a display interface of an electronic device.

### BACKGROUND OF THE DISCLOSURE

The miniaturization of electronic devices and notably of wireless communications devices today is enabling the development of numerous objects referred to as “connected objects”. These are often conventional objects to which communications capacities are added. This might for example be a flower pot capable of informing the user when it needs watering, a bracelet allowing messages to be received or else a watch using which it is possible to take telephone calls. Although it is possible today to miniaturize the electronic circuits of such objects, the means of interaction with the users cannot be miniaturized in the same way. For example, a connected toothbrush may require means of interaction in such a manner that a user can configure an association with a terminal by for example inputting an access code to a wireless network. For this purpose, means of interaction having a minimum ergonomic comfort are necessary, such as for example a screen accompanied by an input device. Owing to the small size of certain types of equipment, the space occupied by these means of interaction must sometimes be reduced to a minimum. For example, a connected toothbrush may comprise a screen of an appropriate size capable of displaying a few characters and a single button allowing the input of information.

The American patent application no. US 2010/0026628 describes a portable apparatus able to be used with a man-machine interface of reduced size composed of a single push-button and of a screen. This patent describes a solution allowing messages to be entered in Morse code using only the push-button as input device. The solution presented aims to distinguish between a short or long push action on the push-button, corresponding respectively to a short or long Morse code pulse. The translation of a sequence of several short or long pulses into a character of the Morse code is triggered by the system at the expiration of a predefined period. The user of such a portable apparatus must therefore input a sequence of pulses corresponding to the Morse code of a character while making sure that he/she does not mark a pause longer than the predefined period between the inputting of two pulses. Otherwise, the translation of the Morse code will be applied to an incorrect sequence of pulses.

As a consequence, there exists a need for a solution for inputting alphanumeric characters applicable to electronic devices having means of interaction reduced to the minimum whose implementation is simple and faster and which consequently allows an increase in the duration of use of a battery of the electronic device.

### SUMMARY

An exemplary embodiment of the invention provides a method for inputting at least one alphanumeric character by means of a user interface of an electronic device, the user interface comprising a display screen with at least a first area for displaying at least one alphanumeric character already input, and a second area for displaying an alphanumeric character in the process of being input, the electronic device also comprising a command input element for entering at least one command for scrolling alphanumeric characters to be applied to an alphanumeric character displayed in the second display area, the method comprising the following steps:
Detection of a scrolling command input carried out by means of said command element triggering a scrolling of alphanumeric characters applied to an alphanumeric character displayed in the second display area,
Display of a current alphanumeric character in the second display area following said scrolling,
Detection of an event indicating an inputting of the current alphanumeric character,
Following the detection of said event, display of the current alphanumeric character in the first display area and elimination of the current alphanumeric character from the second display area.

The method, subject of the invention, allows fast and simple inputting of a series of alphanumeric characters by means of a screen displaying the alphanumeric characters already input and the alphanumeric characters in the process of being input and of a command input element, such as a push-button, or else a predefined area of a touchscreen.

Such a solution limits the number of input errors because the user of the electronic device selects, by means of the command input element, an alphanumeric character rather than, for example, a character in Morse code.

Similarly, such a solution allows the power consumption of the electronic device to be reduced since the number of pulses generated on the command input element is reduced, as is the duration of these pulses. Thus, the solution, subject of the invention, allows a greater autonomy of use of the electronic device.

According to one feature of the method, subject of the invention, the event indicating an input of an alphanumeric character is the detection of a command input effected by means of said command element triggering the input.

In one embodiment of the method, subject of the invention, an alphanumeric character is entered when an input action is carried out by means of the command element. Thus, the inputting of an alphanumeric character requires an action on the part of the user of the electronic device.

According to one feature of the method, subject of the invention, the event indicating an input of an alphanumeric character is the detection of the expiration of a first time period.

In such an embodiment of the method, subject of the invention, an alphanumeric character is entered after the expiration of a predetermined period. Thus, the user of the electronic device does not execute any action in order to validate the alphanumeric character chosen.

According to one feature of the method, subject of the invention, the command input triggering the scrolling of alphanumeric characters in the second display area consists of a short push action on said command element.

In such an embodiment, the command element is for example a push-button or a predetermined area of the display interface when the latter consists of a touchscreen.

With a single pulse of short duration on the command element, the alphanumeric characters are displayed on the screen.

According to one feature of the method, subject of the invention, the command input triggering the data input consists of a long push action on said command element.

In such an embodiment, the command element is for example a push-button or a predetermined area of the display interface when the latter consists of a touchscreen.

With a single pulse of longer duration than the duration of a pulse for triggering the scrolling of the alphanumeric characters, on the command element, the last alphanumeric character displayed on the screen is input.

According to one feature of the method, subject of the invention, when the command input triggering the scrolling of alphanumeric characters in the second display area is a long push action on said command element, the direction of scrolling of the alphanumeric characters in the second display area is reversed.

With a single pulse of longer duration than the duration of a pulse for triggering the scrolling of the alphanumeric characters, on the command element, the direction of scrolling of the alphanumeric characters is reversed. This advantageously allows a letter situated at the end of the alphabet to be input more quickly because it is no longer necessary to run through the latter in the conventional direction.

According to one feature of the method, subject of the invention, when the command input triggering the scrolling of alphanumeric characters in the second display area consists of a long push action on said command element, the speed of scrolling of the alphanumeric characters in the second display area is increased.

With a single pulse of longer duration than the duration of a pulse for triggering the scrolling of the alphanumeric characters, on the command element, the speed of scrolling of the alphanumeric characters is increased. This advantageously allows the user to run through the alphabet more quickly.

According to one feature, the method, subject of the invention, furthermore comprises the following steps:
Detection of an event indicating an end of the inputting of at least one alphanumeric character,
Transmission of the input alphanumeric character to a communications device.

According to one feature of the method, subject of the invention, the event indicating an end of the inputting of an alphanumeric character is the detection of the expiration of a second time period.

Thus, the user of the electronic device does not execute any action in order to validate the transmission of the entered message.

The invention also relates to an electronic device for inputting at least one alphanumeric character by means of a user interface, the user interface comprising a display screen with at least a first area for displaying at least one alphanumeric character already input, and a second area for displaying an alphanumeric character in the process of being input, the electronic device also comprising:
a command input element for entering at least one command for scrolling alphanumeric characters to be applied to an alphanumeric character displayed in the second display area,
a detector of a scrolling command input carried out by means of said command element triggering a scrolling of alphanumeric characters applied to an alphanumeric character displayed in the second display area, a current alphanumeric character in the second display area following said scrolling being displayed on the display screen,
a detector of an event indicating an inputting of the current alphanumeric character, following the detection of said event, the current alphanumeric character being displayed in the first display area and elimination of the current alphanumeric character from the second display area.

Such a device is for example a connected bracelet comprising a screen and a push-button or else a touchscreen, allowing the inputting of alphanumeric characters.

According to other aspects, the invention also relates to a computer program comprising program code instructions for the implementation of the steps of the method for inputting at least one alphanumeric character on a display interface of a connected device previously described, when this program is executed by a computer.

Each of the computer programs described hereinabove may use any given programming language, and may take the form of source code, object code, or of code intermediate between source code and object code, such as in a partially compiled form, or in any other desirable form.

The invention is also aimed at a recording medium readable by a computer on which a computer program such as previously described is recorded.

The information medium may be any given entity or device capable of storing the program. For example, the medium may comprise a storage means, such as a ROM (Read Only Memory), for example a CD ROM or a microelectronic circuit ROM, or else a magnetic recording means, for example a floppy disk or a hard disk.

Furthermore, the information medium may be a transmissible medium such as an electrical or optical signal, which may be channeled via an electrical or optical cable, by radio or by other means. The program according to the invention may in particular be downloaded over a network of the Internet type.

Alternatively, the information medium may be an integrated circuit into which the program is incorporated, the circuit being adapted for executing or for being used in the execution of the method in question.

### BRIEF DESCRIPTION OF THE DRAWINGS

Other features and advantages will become apparent upon reading embodiments described with reference to the drawings in which:

FIG. 1A shows an electronic device, subject of the invention,

FIG. 1B shows the user interface of the electronic device during the inputting of a message of the SMS type by means of the push-button,

FIG. 2 shows a series of steps of a method for inputting a message of the SMS type such as seen by a user of the electronic device according to the invention,

FIG. 3 shows the steps of a method for inputting alphanumeric characters executed by an electronic device, subject of the invention,

FIG. 4 shows the electronic device together with the various modules composing it.

### DETAILED DESCRIPTION OF ILLUSTRATIVE EMBODIMENTS

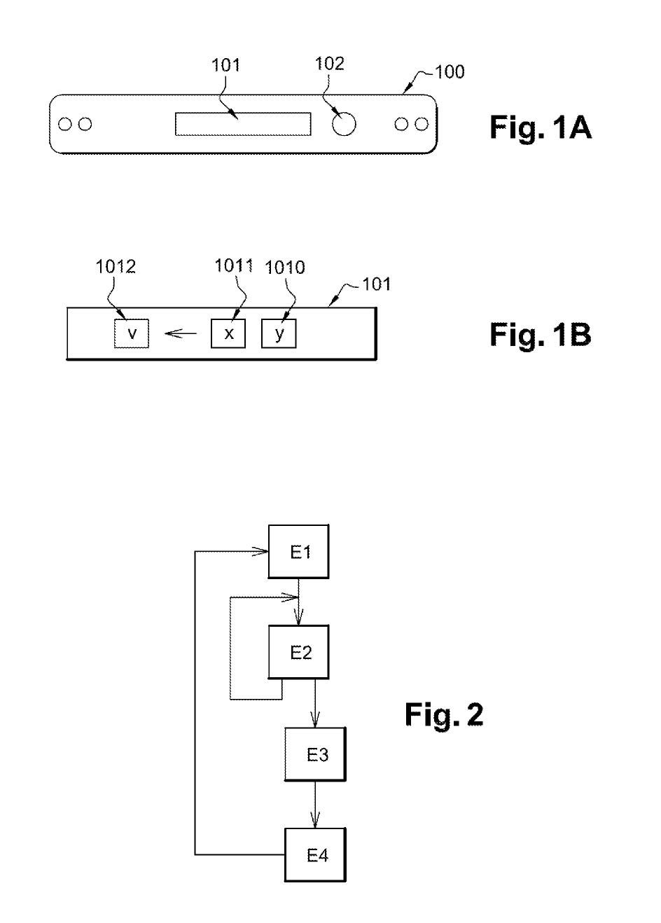

FIG. 1A shows an electronic device 100, such as a connected bracelet. The electronic device 100 comprises a user interface such as a screen 101 and a command input element 102 such as a push-button 102. In another embodiment of the invention, the electronic device comprises a user interface 101 such as a touchscreen. In this embodiment, the command input element is a dedicated area of the touchscreen.

The electronic device 101 comprises means for connecting to a communications network such as a radio transmitter/receiver operating according to the Wi-Fi (Wireless Fidelity) technology such as defined by the working group 802.11 of the IEEE (Institute of Electrical and Electronics Engineers) or else means for connecting to another electronic device, such as a mobile telephone or a digital tablet, itself connected to the communications network. Such means for connecting to another electronic device are for example a Bluetooth® transmitter/receiver. In another embodiment, the electronic device 100 comprises means for connecting to a communications network such as a radio transmitter/receiver operating according to 3G or 4G technology.

The push-button 102 allows two types of interactions with the user interface 101: a short push action and a long push action which differ from one another by the period of time during which a pressure is applied to the push-button 102. Several types of long push actions may be differentiated by increasing the pressure duration on the push-button. Depending on the nature of the interaction, short or long push action, a certain type of action is executed by the electronic device 100 and displayed by means of the user interface 100.

FIG. 1B shows the user interface 101 during the inputting of a message of the SMS (Short Message System) type by means of the push-button 102.

The user interface 101 comprises a first display area 1010 for an alphanumeric character in the process of being input and at least a second display area 1011, 1012 for at least one alphanumeric character already input.

The alphanumeric characters in the process of being input scroll into the display area 1010 subsequent to an action carried out on the push-button 102. In one embodiment of the invention, the scrolling of the alphanumeric characters is vertical, from the top of the user interface 101 toward the bottom starting with the first letter of the alphabet. Once the alphabet has been exhausted, the digits subsequently scroll from 0 through 9, then the punctuation marks. Other modes of scrolling of the alphanumeric characters into the display area 1010 are possible, such as a horizontal scrolling.

Once an alphanumeric character has been input, it is eliminated from the display area 1010 so as to be displayed in the adjacent display area 1011. The alphanumeric character previously input is, for its part, eliminated from the display area 1011 so as to be displayed in the adjacent display area 1012 and so on.

FIG. 2 shows a series of steps of a method for inputting a message of the SMS type implemented by the electronic device 100 such as seen by a user of the electronic device 100.

During a step E1, the first letter of the alphabet is displayed in the display area 1010.

During a step E2, the user of the electronic device 100 performs a short push action on the push-button 102. The detection of the short push action on the push-button 102 triggers the scrolling of an alphanumeric character into the display area 1010. The second letter of the alphabet is now displayed in the display area 1010. The step E2 is carried out as many times as is necessary until the desired alphanumeric character is displayed in the display area 1010.

During a step E3, the user of the electronic device 100 performs a long push action on the push-button 102. The detection of the long push action on the push-button 102 triggers the inputting of the alphanumeric character currently displayed in the display area 1010.

During a step E4, the alphanumeric character already input is eliminated from the display area 1010 so as to be displayed in the adjacent display area 1011.

The steps E1 to E4 are repeated as many times as necessary until the entry of the SMS message by the user of the electronic device 100 is complete.

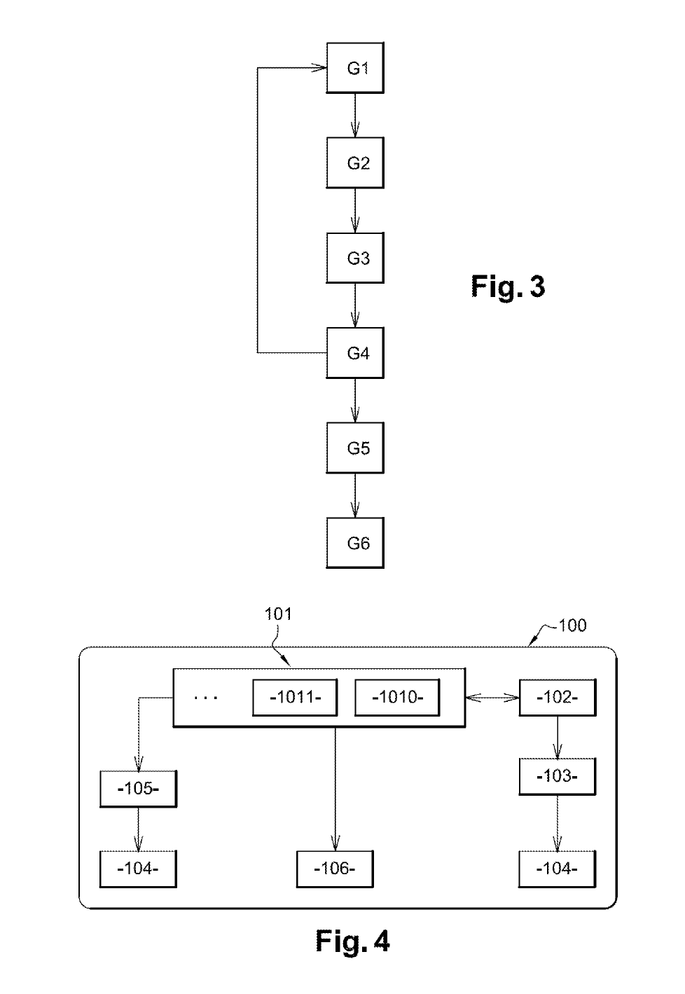

FIG. 3 shows the steps of a method for inputting alphanumeric characters executed by an electronic device 100.

During a step G1, the electronic device 100 detects a scrolling command input effected by means of a command element 102, such as a push-button, triggering the scrolling of the alphanumeric characters into the display area 1010.

In one embodiment of the method, subject of the invention, the command input triggering the scrolling of alphanumeric characters into the display area 110 consists of a short push action on the push-button 102.

In another embodiment of the method, subject of the invention, when the command input triggering the scrolling of alphanumeric characters into the display area 1010 is a long push action on the push-button, the direction of scrolling of the alphanumeric characters into the second display area is reversed, the first alphanumeric character displayed being for example the last letter of the alphabet and the following alphanumeric character the penultimate letter of the alphabet.

In a third embodiment of the method, subject of the invention, when the command input triggering the scrolling of alphanumeric characters into the display area 1010 consists of a long push action on the push-button 102, the speed of scrolling of the alphanumeric characters into the display area 1010 is increased.

In a fourth embodiment of the method, subject of the invention, the command input triggering the scrolling of alphanumeric characters into the display area 1010 consists of a first short push action on the push-button 102; this triggers an automatic scrolling of the alphanumeric characters into the display area 1010. A second short push action on the push-button 102 stops the automatic scrolling.

During a step G2, the current alphanumeric character is displayed in the display area 1010 following said scrolling.

During a step G3, an event indicating an inputting of the current alphanumeric character is detected.

In one embodiment of the method, subject of the invention, the event indicating an input of an alphanumeric character is the detection of a command input effected by means of the push-button triggering the input. Such a command input is for example a long push action on the push-button 102.

In one embodiment of the method, subject of the invention, the event indicating an input of an alphanumeric character is the detection of the expiration of a first time period T1.

During a step G4, following the detection of said event, the current alphanumeric character is displayed in the display area 1011 and is eliminated from the display area 1010.

The steps G1 to G4 are repeated as many times as necessary in order to input a message of the SMS type.

During a step G5, an event indicating an end of the inputting of at least one alphanumeric character is detected. This means that the inputting of the message of the SMS type is finished and that the latter is ready to be transmitted.

The event indicating an end of the inputting of the message of the SMS type is the detection of the expiration of a second time period T2.

During a step G6, the alphanumeric characters already input forming the message of the SMS type are transmitted to a communications device.

FIG. 4 shows the electronic device 100 together with the various modules composing it.

The electronic device 100 comprises a user interface such as a screen 101 and a command input element 102 such as a push-button 102. In another embodiment of the invention, the electronic device comprises a user interface 101 such as a touchscreen. In this embodiment, the command input element is a dedicated area of the touchscreen.

The user interface 101 comprises a first area 1010 for displaying an alphanumeric character in the process of being input and at least a second area 1011, 1012 for displaying at least one alphanumeric character already input.

The alphanumeric characters in the process of being input scroll into the display area 1010 subsequent to an action carried out on the push-button 102. In one embodiment of the invention, the scrolling of the alphanumeric characters is vertical, from the top of the user interface 101 toward the bottom starting with the first letter of the alphabet. Once the alphabet has been exhausted, the digits subsequently scroll from 0 through 9, then the punctuation marks. Other modes of scrolling of the alphanumeric characters into the display area 1010 are possible, such as a horizontal scrolling.

Once an alphanumeric character has been input, it is eliminated from the display area 1010 so as to be displayed in the adjacent display area 1011. As regards the alphanumeric character previously input, this is eliminated from the display area 1011 so as to be displayed in the adjacent display area 1012 and so on.

The electronic device 100 comprises a command input element detector 103 for inputting at least one command for scrolling alphanumeric characters to be applied to an alphanumeric character displayed in the display area 1010. This detector 103 is connected to the push-button 102 and to the user interface 101.

The detector 103 is connected to a module for measuring a duration 104. The duration measurement module 104 allows the duration of a pulse effected on the push-button 102 to be measured and thus the short push actions to be differentiated from the long push actions.

The electronic device 100 also comprises a detector 105 of an event indicating an inputting of the current alphanumeric character. Following the detection of said event, the current alphanumeric character is displayed in the display area 1011 and eliminated from the display area 1010.

The detector 105 is connected to the duration measurement module 104. The duration measurement module 104 measures a duration whose expiration is the event indicating an input of an alphanumeric character.

Finally, the electronic device 100 comprises a transmitter/receiver module 106 capable of transmitting and of receiving messages of the SMS type. The transmitter/receiver module 106 is connected to the user interface 101.

An exemplary embodiment of the invention overcomes the drawbacks of the prior art discussed above.

Although the present disclosure has been described with reference to one or more examples, workers skilled in the art will recognize that changes may be made in form and detail without departing from the scope of the disclosure and/or the appended claims.

1. A method comprising:
inputting at least one alphanumeric character by using a user interface of an electronic device, the user interface comprising a display screen with at least a first area for displaying at least one alphanumeric character already input, and a second area for displaying an alphanumeric character in the process of being input, the electronic device also comprising a command input element for entering at least one command for scrolling alphanumeric characters to be applied to an alphanumeric character displayed in the second display area, wherein inputting comprises:
detecting a scrolling command input carried out by using said command input element triggering a scrolling of alphanumeric characters applied to an alphanumeric character displayed in the second display area,
displaying a current alphanumeric character in the second display area following said scrolling,
detecting an event indicating an inputting of the current alphanumeric character, and
following the detecting of said event, displaying the current alphanumeric character in the first display area and eliminating the current alphanumeric character from the second display area.

2. The method for inputting at least one alphanumeric character on a display interface of an electronic device as claimed in claim 1, in which the event indicating an input of an alphanumeric character is detection of a command input effected by using said command input element triggering the input.

3. The method for inputting at least one alphanumeric character on a display interface of an electronic device as claimed in claim 1, in which the event indicating an input of an alphanumeric character is detection of an expiration of a first time period.

4. The method for inputting at least one alphanumeric character on a display interface of an electronic device as claimed in claim 1, in which the command input triggering the scrolling of alphanumeric characters in the second display area consists of a short push action on said command input element.

5. The method for inputting at least one alphanumeric character on a display interface of an electronic device as claimed in claim 2, in which the command input of the detected event triggering the input of an alphanumeric character consists of a long push action on said command input element.

6. The method for inputting at least one alphanumeric character on a display interface of an electronic device as claimed in claim 4, in which, when the command input triggering the scrolling of alphanumeric characters in the second display area is a long push action on said command input element, the direction of scrolling of the alphanumeric characters in the second display area is reversed.

7. The method for inputting at least one alphanumeric character on a display interface of an electronic device as claimed in claim 1, in which, when the command input triggering the scrolling of alphanumeric characters in the second display area consists of a long push action on said command input element, the speed of scrolling of the alphanumeric characters in the second display area is increased.

8. The method for inputting at least one alphanumeric character on a display interface of an electronic device as claimed in claim 1, furthermore comprising:
detecting an event indicating an end of the inputting of at least one alphanumeric character,
transmitting the input alphanumeric character to a communications device.

9. The method for inputting at least one alphanumeric character on a display interface of an electronic device as claimed in claim 8, in which the event indicating an end of the inputting of an alphanumeric character is detection of an expiration of a second time period.

10. An electronic device for inputting at least one alphanumeric character, comprising:
a user interface comprising a display screen with at least a first area for displaying at least one alphanumeric character already input, and a second area for displaying an alphanumeric character in the process of being input;
a command input element for entering at least one command for scrolling alphanumeric characters to be applied to an alphanumeric character displayed in the second display area,
a detector of a scrolling command input carried out by using said command input element triggering a scrolling of alphanumeric characters applied to an alphanumeric character displayed in the second display area, a current alphanumeric character in the second display area following said scrolling being displayed on the display screen, and
a detector of an event indicating an inputting of the current alphanumeric character, following the detection of said event, the current alphanumeric character being displayed in the first display area and elimination of the current alphanumeric character from the second display area.

11. A non-transitory computer-readable medium comprising a computer program stored thereon and executable by a processor of an electronic device, wherein the program comprises program code instructions for implementation of a method for inputting at least one alphanumeric character on a user interface of the electronic device when said program is executed by the processor, wherein the program configures the electronic device to perform acts comprising:
inputting the at least one alphanumeric character through the user interface, the user interface comprising a display screen with at least a first area for displaying at least one alphanumeric character already input, and a second area for displaying an alphanumeric character in the process of being input, the electronic device also comprising a command input element for entering at least one command for scrolling alphanumeric characters to be applied to an alphanumeric character displayed in the second display area, wherein inputting comprises:
detecting a scrolling command input carried out by using said command input element triggering a scrolling of alphanumeric characters applied to an alphanumeric character displayed in the second display area, displaying a current alphanumeric character in the second display area following said scrolling,
detecting an event indicating an inputting of the current alphanumeric character, and
following the detecting of said event, displaying the current alphanumeric character in the first display area and eliminating the current alphanumeric character from the second display area.

12. The method as claimed in claim 1, wherein the command input element is a pushbutton.

13. The method as claimed in claim 1, wherein the command input element is a dedicated touch screen area of the user interface.
